(19) United States
(12) Patent Application Publication
(10) Pub. No.: US 2026/0066426 A1
(43) Pub. Date: Mar. 5, 2026

(54) POWER STORAGE DEVICE

(71) Applicant: TOYOTA JIDOSHA KABUSHIKI KAISHA, Toyota-shi (JP)

(72) Inventors: Shigeyuki INOUE, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 19/242,068

(22) Filed: Jun. 18, 2025

(30) Foreign Application Priority Data
Aug. 29, 2024 (JP) 2024-147189

(51) Int. Cl. H01M 50/242; H01M 10/613; H01M 10/625; H01M 10/647; H01M 50/209; H01M 50/249; H01M 50/264; H01M 50/367

(52) U.S. Cl. CPC H01M 50/242; H01M 10/613; H01M 10/625; H01M 10/647; H01M 50/209; H01M 50/249; H01M 50/264; H01M 50/367

(57) ABSTRACT

A power storage device includes a first power storage stack including a plurality of power storage cells disposed in a first direction, a second power storage stack including a plurality of power storage cells and facing the first power storage stack in a second direction, an upper wall covering the first power storage stack and the second power storage stack, and a reinforcing member provided on the upper wall. The upper wall includes a top portion located above and between the first power storage stack and the second power storage stack. The reinforcing member is provided on the top portion.

### CROSS-REFERENCE TO RELATED APPLICATION

This application claims priority to Japanese Patent Application No. 2024-147189 filed on Aug. 29, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

For example, Japanese Unexamined Patent Application Publication (Translation of PCT Application) No. 2022-525014 (JP 2022-525014 A) discloses a power battery pack including a plurality of unit cells and a housing device. The housing device includes a module top plate.

### SUMMARY

In the power storage device as described in JP 2022-525014 A, there is room for improvement, particularly in improving the bending rigidity of the upper wall covering a power storage stack.

An object of the present disclosure is to provide a power storage device that is able to improve the bending rigidity of an upper wall.

A power storage device according to an aspect of the present disclosure includes a first power storage stack including a plurality of power storage cells disposed in a first direction, a second power storage stack including a plurality of power storage cells disposed in the first direction, and facing the first power storage stack in a second direction orthogonal to both the first direction and an up-down direction, an upper wall covering the first power storage stack and the second power storage stack, and a reinforcing member provided on the upper wall. The upper wall includes a top portion located above and between the first power storage stack and the second power storage stack, and the reinforcing member is provided on the top portion.

According to the present disclosure, it is possible to provide a power storage device that is able to improve the bending rigidity of an upper wall.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a vehicle including a power storage device according to an embodiment of the present disclosure;

FIG. 2 is a perspective view schematically illustrating the power storage device, a frame member, a front component member, and a rear component member;

FIG. 3 is a sectional view taken along line III-III in FIG. 2; and

FIG. 4 is a cross-sectional view taken along line IV-IV in FIG. 3.

### DETAILED DESCRIPTION OF EMBODIMENTS

An embodiment of the present disclosure will be described with reference to the drawings. In the drawings referred to below, the same or corresponding members are given the same numbers.

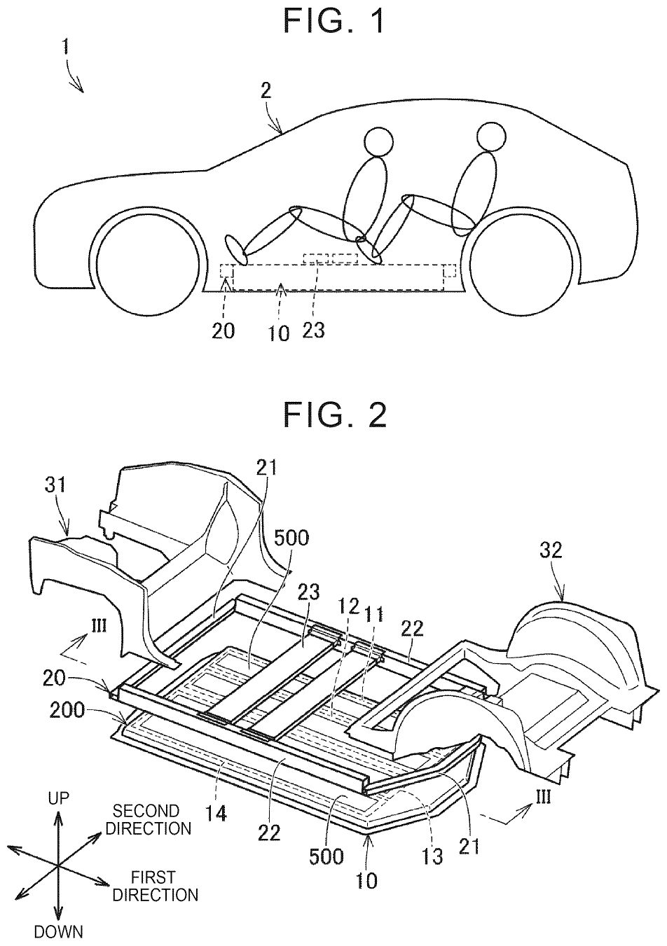

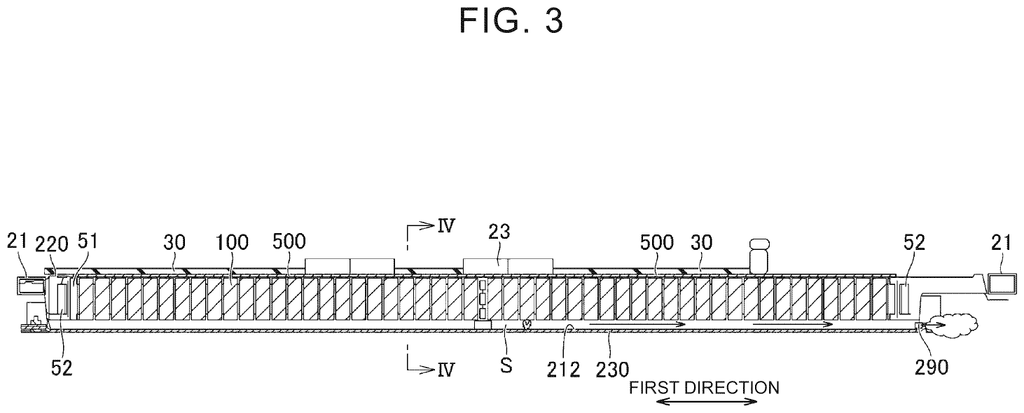

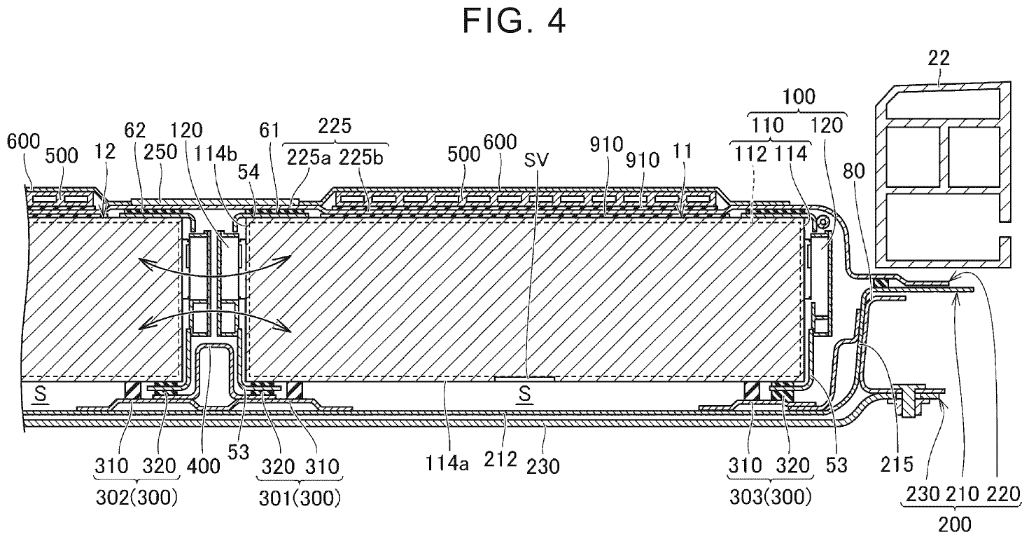

FIG. 1 is a diagram schematically illustrating a vehicle including a power storage device according to an embodiment of the present disclosure. FIG. 2 is a perspective view schematically illustrating the power storage device, a frame member, and a vehicle frame. FIG. 3 is a sectional view taken along line III-III in FIG. 2. FIG. 4 is a cross-sectional view taken along line IV-IV in FIG. 3.

As shown in FIG. 1, a vehicle 1 includes a vehicle body 2 and a power storage device 10. Examples of the vehicle 1 include a hybrid electric vehicle, a plug-in hybrid electric vehicle, a battery electric vehicle, and the like.

As shown in FIGS. 1 and 2, the vehicle body 2 includes a frame member 20, a front component member 31, and a rear component member 32. The frame member 20 is disposed at the bottom portion of the vehicle body 2. The frame member 20 has a pair of first frames 21, a pair of second frames 22, and a cross frame 23.

The first frames 21 face each other in the first direction. The first direction may be a direction parallel to the front-rear direction of the vehicle 1. In the example shown in FIG. 2, the first frame 21 disposed at the front has a shape extending along a second direction orthogonal to both the first direction and the up-down direction. The first frame 21 disposed at the rear extends in the second direction and has a shape that protrudes rearward. The second direction may be a direction parallel to the right-left direction (width direction) of the vehicle 1.

The second frames 22 face each other in the second direction. Each of the second frames 22 has a shape extending along the first direction. The end portions of each second frame 22 in the first direction are connected to the first frames 21. The second frames 22 are formed into a substantially rectangular tubular shape, and surround the power storage device 10 together with the first frames 21.

The cross frame 23 is disposed between the first frames 21 and connects the second frames 22 to each other. The cross frame 23 constitutes, for example, a seat cross.

The front component member 31 is connected to the front portion of the frame member 20. The rear component member 32 is connected to the rear portion of the frame member 20. Each of the component members 31, 32 may be formed by aluminum die casting.

The power storage device 10 is attached to the frame member 20. As shown in FIGS. 2 and 3, the power storage device 10 is disposed below the cross frame 23. As shown in FIGS. 1 to 4, the power storage device 10 includes four power storage stacks 11 to 14, a housing 200, a reinforcing member 250, a support member 300, connecting portions 400, coolers 500, and covering members 600. The number of the power storage stacks is not limited to four. The covering members 600 are omitted in FIG. 2.

Each of the power storage stacks 11 to 14 includes at least one power storage cell 100. In the present embodiment, each of the power storage stacks 11 to 14 includes a power storage cell group including a plurality of (for example, 50) power storage cells 100 arranged side by side along the first direction. Each of the power storage stacks 11 to 14 may further include a plurality of spacers. Each spacer is disposed between a pair of adjacent power storage cells 100 in the power storage cell group. Each of the power storage stacks 11 to 14 is formed in a rectangular parallelepiped shape that is elongated in the first direction. As shown in FIG. 2, the four power storage stacks 11 to 14 are arranged side by side along the second direction.

As shown in FIG. 3, a pair of end plates 51 is provided such that one end plate 51 is provided on each side of the plurality of power storage cells 100 and the end plates 51 sandwich the power storage cells 100 from both sides in the first direction. A monitoring unit (smart battery management) 52 is disposed on the outside of each end plate 51 in the first direction.

As shown in FIG. 4, each power storage cell 100 has a cell body 110 and a pair of external terminals 120. FIG. 4 illustrates the power storage cell 100 included in the first power storage stack 11 and a part of the power storage cell 100 included in the second power storage stack 12.

The cell body 110 includes an electrode body 112 and a cell case 114. The thickness direction of the cell body 110 corresponds to the first direction. The width direction of the cell body 110 (the direction orthogonal to both the thickness direction and the up-down direction) corresponds to the second direction.

The electrode body 112 may be made up of a wound body in which a positive electrode sheet and a negative electrode sheet are wound with a separator interposed therebetween, or may be made up of a laminate in which a positive electrode sheet and a negative electrode sheet are stacked with a separator interposed therebetween. The electrode body 112 is formed in a shape that is elongated in the second direction.

The cell case 114 houses the electrode body 112. The cell case 114 is formed in a rectangular parallelepiped shape. The cell case 114 is made of a metal such as aluminum. The cell case 114 includes a valve mounting surface 114a and terminal mounting surfaces 114b.

A safety valve SV is provided on the valve mounting surface 114a. In the present embodiment, the valve mounting surface 114a is made up of the lower surface of the cell case 114. However, the valve mounting surface 114a may be made up of the upper surface of the cell case 114.

The external terminal 120 is provided on the terminal mounting surface 114b. In the present embodiment, the terminal mounting surface 114b is made up of the side surface of the cell case 114 in the second direction. That is, each external terminal 120 protrudes in the second direction from the side surface of the cell case 114 in the second direction. One of the external terminals 120 protrudes from the side surface of the cell case 114 on one side in the second direction. The other one of the external terminals 120 protrudes from the side surface of the cell case 114 on the other side in the second direction.

The power storage device 10 further includes a restraining member that restrains the power storage cells 100 included in each of the power storage stacks 11 to 14 from both sides in the first direction. As shown in FIG. 4, the restraining member includes a lower restraining band 53 and an upper restraining band 54.

The lower restraining band 53 is disposed on the bottom portion of each of the power storage stacks 11 to 14. Specifically, the lower restraining band 53 restrains the lower corners of the external terminal 120 of each cell case 114 from both sides in the first direction.

The upper restraining band 54 is disposed on the top portion of each of the power storage stacks 11 to 14. Specifically, the upper restraining band 54 restrains the upper corners of the external terminal 120 of each cell case 114 from both sides in the first direction.

The housing 200 houses the power storage cells 100. In the present embodiment, the housing 200 houses the four power storage stacks 11 to 14. As shown in FIG. 4, the housing 200 has a lower case 210, an upper cover 220, and a panel member 230.

The lower case 210 is open upward. The lower case 210 has a bottom wall 212 and a peripheral wall 215.

The bottom wall 212 is located below each of the power storage stacks 11 to 14. The bottom wall 212 may be formed in a flat plate shape.

The peripheral wall 215 stands up from the peripheral edge portion of the bottom wall 212. The peripheral wall 215 has a shape that surrounds the bottom portions of the power storage stacks 11 to 14 collectively.

The upper cover 220 is disposed above the power storage cells 100. In the present embodiment, the upper cover 220 is disposed above the four power storage stacks 11 to 14. The upper cover 220 houses, together with the lower case 210, four power storage stacks 11 to 14 in a sealed state. The peripheral edge portion of the upper cover 220 is connected to the peripheral edge portion of the lower case 210 by bolts or the like via a sealing member.

As shown in FIG. 4, the upper cover 220 has an upper wall 225. The upper wall 225 is provided above at least one power storage cell 100. In the present embodiment, the upper wall 225 is provided above the four power storage stacks 11 to 14. The upper wall 225 has a top portion 225a and four recesses 225b.

The top portion 225a is located above and between the pair of power storage stacks adjacent to each other in the second direction. The top portion 225a is formed flat. The top portion 225a overlaps in the up-down direction with the end portions of each power storage stack in the second direction.

Each recess 225b is recessed downward from the top portion 225a. Each recess 225b is formed flat. Each recess 225b is formed above the center portion of each of the power storage stacks 11 to 14 in the second direction. As shown in FIG. 4, the length of each recess 225b in the second direction is shorter than the length of the power storage cell 100 in the second direction. Each recess 225b is in contact with the upper surface of the cell case 114 via a thermally conductive adhesive 910.

The panel member 230 is provided below the lower case 210. The panel member 230 has a function of protecting the lower case 210. The panel member 230 may be formed in a flat plate shape. As shown in FIG. 4, the peripheral edge portion of the panel member 230 is connected to the lower case 210 via a bracket 80.

The support member 300 is provided on the bottom wall 212. The support member 300 supports each of the power storage stacks 11 to 14. The support member 300 includes a first lower connection portion 301, a second lower connection portion 302, and an end lower connection portion 303. In the present embodiment, each of the lower connection portions 301 to 303 has a structure corresponding to each other. Therefore, the first lower connection portion 301 will be described below.

The first lower connection portion 301 connects the bottom wall 212 and the first power storage stack 11. The first lower connection portion 301 includes a support portion 310 and an adhesive member 320.

The support portion 310 is provided on the bottom wall 212. The support portion 310 is disposed at a position spaced apart from the safety valve SV in the second direction (width direction). The support portion 310 is disposed below the end portion of the cell case 114 in the second direction. The support portion 310 has a shape that protrudes upward. The support portion 310 is made of metal. The edge portion of the support portion 310 is connected to the bottom wall 212 by welding or the like.

The adhesive member 320 connects the support portion 310 and the first power storage stack 11. The adhesive member 320 may be made of urethane resin. The adhesive member 320 extends in the first direction. The adhesive member 320 bonds the top surface of the support portion 310 to the valve mounting surface 114a of each cell case 114 included in the first power storage stack 11. In the present embodiment, the adhesive member 320 bonds the lower restraining band 53 and the first power storage stack 11 together.

The second lower connection portion 302 connects the bottom wall 212 and the second power storage stack 12. The end lower connection portion 303 connects the bottom wall 212 and the outer end portion in the second direction of the power storage stack (in the present embodiment, the first power storage stack 11 and the fourth power storage stack 14) disposed outermost in the second direction.

Each of the power storage stacks 11 to 14, the bottom wall 212, and the support member 300 define a space S below each of the power storage stacks 11 to 14. In the present embodiment, the support member 300 defines, together with each of the power storage stacks 11 to 14 and the bottom wall 212, the space S below each of the power storage stacks 11 to 14. That is, in the present embodiment, four spaces S are formed inside the housing 200.

As shown in FIG. 3, each space S extends in the first direction. Each space S functions as a smoke exhaust path (hereinafter referred to as “smoke exhaust path S”). The smoke exhaust path S is a path for discharging gas discharged from the safety valve SV of the power storage cell 100 to the outside of the housing 200. Each smoke exhaust path S is connected to a common space within the housing 200 at an end portion of the smoke exhaust path S in the first direction.

As shown in FIG. 3, an explosion-proof valve 290 is provided on the peripheral wall 215 at a portion facing the smoke exhaust path S in the first direction. The explosion-proof valve 290 is provided in the common space within the housing 200. The explosion-proof valve 290 releases pressure in the housing 200. The explosion-proof valve 290 opens when the pressure inside the housing 200 reaches or exceeds a reference value. The explosion-proof valve 290 is made up of a check valve. As shown in FIG. 3, when gas is discharged from any of the power storage cells 100, the gas spreads in the first direction through the smoke exhaust path S and is discharged to the outside of the housing 200 through the explosion-proof valve 290.

In the present embodiment, the power storage device 10 includes an upper connection portion. As shown in FIG. 4, the upper connection portion includes a first upper connection portion 61 and a second upper connection portion 62.

The first upper connection portion 61 connects the first power storage stack 11 and the top portion 225a. The first upper connection portion 61 bonds the upper surface of each cell case 114 of the first power storage stack 11 and the top portion 225a together. In the present embodiment, the first upper connection portion 61 bonds the upper restraining band 54 and the first power storage stack 11 together.

The second upper connection portion 62 connects the second power storage stack 12 and the top portion 225a. The second upper connection portion 62 bonds the upper surface of each cell case 114 of the second power storage stack 12 and the top portion 225a together. In the present embodiment, the second upper connection portion 62 bonds the upper restraining band 54 and the second power storage stack 12 together.

The connecting portion 400 connects the first lower connection portion 301 and the second lower connection portion 302. Specifically, the connecting portion 400 connects the support portion 310 of the first lower connection portion 301 and the support portion 310 of the second lower connection portion 302. The connecting portion 400 is connected to the support portions 310 by welding or the like.

The connecting portion 400 has a shape that protrudes upward from the support portions 310. The connecting portion 400 is disposed between the lower restraining band 53 attached to the first power storage stack 11 and the lower restraining band 53 attached to the second power storage stack 12. The connecting portion 400 is disposed below a pair of the external terminals 120 adjacent to each other in the second direction. The connecting portion 400 overlaps in the up-down direction with both of the external terminals 120 that face each other in the second direction. The connecting portion 400 extends along the first direction. The end portions of the connecting portion 400 in the first direction may be in contact with the peripheral wall 215 or may be spaced apart from the peripheral wall 215.

The cooler 500 cools at least one power storage cell 100. A cooling medium (such as water) flows through the cooler 500. As shown in FIGS. 2 to 4, the coolers 500 are provided on the upper wall 225. More specifically, the coolers 500 are provided in the recesses 225b of the upper wall 225.

Each of the coolers 500 is in thermal contact with at least one power storage cell 100 via the upper wall 225. In the present embodiment, the thermally conductive adhesive 910 extending along the first direction is provided between the cooler 500 and the recess 225b. That is, in the present embodiment, the cooler 500 is in thermal contact with each of the power storage stacks 11 to 14 via the upper wall 225 and the thermally conductive adhesive 910. Thermal contact includes a mode in which the cooler 500 contacts the power storage cell 100 only via the upper wall 225, and a mode in which the cooler 500 indirectly contacts the power storage cell 100 via a thermally conductive member (such as an adhesive or a fixing member).

The covering members 600 cover the coolers 500. The covering members 600 may be formed of a material having thermal insulation properties. The covering members 600 are omitted in FIGS. 2 and 3.

The coolers 500 and the covering members 600 form at least a part of a floor portion 30 (see FIG. 3) of a vehicle cabin. The floor portion 30 of the vehicle cabin may include, in addition to the coolers 500 and the covering members 600, floor component members (such as a cushioning member, carpet, etc.) located on the covering members 600. The floor component members are omitted in FIGS. 2 and 4.

The reinforcing member 250 is provided on the upper wall 225. Specifically, the reinforcing member 250 is fixed to the top portion 225a by adhesion, welding, or the like. The reinforcing member 250 extends in the first direction. The reinforcing member 250 may be formed in a flat plate shape. The reinforcing member 250 has a thickness greater than a thickness of the top portion 225a. The reinforcing member 250 is omitted in FIG. 2. The reinforcing member 250 overlaps with the first upper connection portion 61 and the second upper connection portion 62 in the up-down direction. The reinforcing member 250 may be in contact with the covering members 600 in the second direction. The reinforcing member 250 has a thickness greater than a thickness of the covering member 600.

In the power storage device 10 described above, when gas is discharged downward from the safety valve SV due to a short circuit or the like in any of the power storage cells 100, the gas flows into the smoke exhaust path S. Then, the gas that has flowed into the smoke exhaust path S spreads in the first direction and is discharged from the housing 200 through the explosion-proof valve 290 as shown in FIG. 3. This restrains the contents (so-called debris) of the power storage cell 100 included in the gas from adhering to the external terminal 120 of the power storage cell 100 and the like.

Furthermore, in this power storage device 10, the reinforcing member 250 is provided on the top portion 225a located above and between the first power storage stack 11 and the second power storage stack 12, thereby improving the bending rigidity of the top portion 225a. This suppresses damage to the top portion 225a when an external force (bending moment indicated by the arrow in FIG. 4) that causes the top portion 225a to protrude downward or upward acts on the power storage device 10.

It will be understood by a person skilled in the art that the exemplary embodiments described above are examples of the following aspects.

### First Aspect

A power storage device includes a first power storage stack including a plurality of power storage cells disposed in a first direction, a second power storage stack including a plurality of power storage cells disposed in the first direction, and facing the first power storage stack in a second direction orthogonal to both the first direction and an up-down direction, an upper wall covering the first power storage stack and the second power storage stack, and a reinforcing member provided on the upper wall. The upper wall includes a top portion located above and between the first power storage stack and the second power storage stack, and the reinforcing member is provided on the top portion.

In this power storage device, the reinforcing member is provided on the top portion located above and between the first power storage stack and the second power storage stack, thereby improving the bending rigidity of the top portion. This suppresses damage to the top portion when an external force that causes the top portion to protrude downward or upward acts on the power storage device.

### Second Aspect

The power storage device according to the first aspect further includes a bottom wall disposed below the first power storage stack and the second power storage stack, a first lower connection portion that connects the bottom wall and the first power storage stack, a second lower connection portion that connects the bottom wall and the second power storage stack, a first upper connection portion that connects the first power storage stack and the top portion; and a second upper connection portion that connects the second power storage stack and the top portion.

In this aspect, the bottom wall, the power storage stack, and the upper wall are integrated via the lower connection portions and the upper connection portions, thereby further improving the bending rigidity of the power storage device.

### Third Aspect

The power storage device according to the second aspect further includes a connecting portion that connects the first lower connection portion and the second lower connection portion. The first lower connection portion includes a first support portion provided on the bottom wall, and a first adhesive member that connects the first support portion and the first power storage stack. The second lower connection portion includes a second support portion provided on the bottom wall, and a second adhesive member that connects the second support portion and the second power storage stack. The connecting portion connects the first support portion and the second support portion, and has a shape that protrudes upward.

In this aspect, the bending rigidity of the power storage device is further improved.

### Fourth Aspect

In the power storage device according to the second aspect or the third aspect, the reinforcing member overlaps with the first upper connection portion and the second upper connection portion in the up-down direction, and has a thickness greater than a thickness of the top portion.

### In This Aspect, the Bending Rigidity of the Top Portion Is Further Improved.

### Fifth Aspect

The power storage device according to any one of the first aspect to the fourth aspect further includes a cooler disposed on the upper wall and configured to cool the first power storage stack and the second power storage stack, and a covering member that covers the cooler. The upper wall further includes a recess that is recessed downward from the top portion. The cooler is disposed in the recess. The reinforcing member has a thickness greater than a thickness of the covering member.

In this aspect, the bending rigidity of the top portion is further improved.

The embodiment disclosed this time should be considered to be illustrative in all respects and not restrictive. The scope of the present disclosure is indicated by the claims rather than the description of the embodiment described above, and all changes within the meaning and scope equivalent to the claims are included.

What is claimed is:

1. A power storage device comprising:
a first power storage stack including a plurality of power storage cells disposed in a first direction;
a second power storage stack including a plurality of power storage cells disposed in the first direction, and facing the first power storage stack in a second direction orthogonal to both the first direction and an up-down direction;
an upper wall covering the first power storage stack and the second power storage stack; and
a reinforcing member provided on the upper wall, wherein
the upper wall includes a top portion located above and between the first power storage stack and the second power storage stack, and
the reinforcing member is provided on the top portion.

2. The power storage device according to claim 1, further comprising:
a bottom wall disposed below the first power storage stack and the second power storage stack;
a first lower connection portion that connects the bottom wall and the first power storage stack;
a second lower connection portion that connects the bottom wall and the second power storage stack;
a first upper connection portion that connects the first power storage stack and the top portion; and
a second upper connection portion that connects the second power storage stack and the top portion.

3. The power storage device according to claim 2, further comprising a connecting portion that connects the first lower connection portion and the second lower connection portion, wherein:
the first lower connection portion includes
a first support portion provided on the bottom wall, and
a first adhesive member that connects the first support portion and the first power storage stack;
the second lower connection portion includes
a second support portion provided on the bottom wall, and
a second adhesive member that connects the second support portion and the second power storage stack; and
the connecting portion connects the first support portion and the second support portion, and has a shape that protrudes upward.

4. The power storage device according to claim 2, wherein the reinforcing member overlaps with the first upper connection portion and the second upper connection portion in the up-down direction, and has a thickness greater than a thickness of the top portion.

5. The power storage device according to claim 1, further comprising:
a cooler disposed on the upper wall and configured to cool the first power storage stack and the second power storage stack; and
a covering member that covers the cooler, wherein
the upper wall further includes a recess that is recessed downward from the top portion,
the cooler is disposed in the recess, and
the reinforcing member has a thickness greater than a thickness of the covering member.
